(19) United States
(12) Patent Application Publication
(10) Pub. No.: US 2024/0059241 A1
(43) Pub. Date: Feb. 22, 2024

(54) OCCUPANT PROTECTION DEVICE

(71) Applicant: TOYODA GOSEI CO., LTD., Kiyosu-shi (JP)

(72) Inventors: Yuji MATSUZAKI, Kiyosu-shi (JP); Akira YASUDA, Kiyosu-shi (JP); Yuto NODA, Kiyosu-shi (JP); Takuya KUSUMURA, Kiyosu-shi (JP)

(21) Appl. No.: 18/446,654

(22) Filed: Aug. 9, 2023

(30) Foreign Application Priority Data
Aug. 17, 2022 (JP) 2022-130292

(51) Int. Cl. B60R 21/18; B60R 21/207; B60R 21/231

(52) U.S. Cl. CPC B60R 21/18; B60R 21/207; B60R 21/231; B60R 2021/0044

(57) ABSTRACT

An occupant protection device is for protecting an occupant seated on a seat, and includes an airbag, a holding body in which the folded airbag is housed and held, and an inflator that supplies an inflating gas to the airbag. The airbag is configured to inflate in such a way as to cover a front of the occupant, and includes an occupant side wall portion which can restrain an upper body of the occupant by being disposed on the occupant side when inflation is completed. The occupant side wall portion has a chest portion restraining region that can restrain a chest portion of the occupant by being disposed in an intermediate region in up-down direction sides when inflation is completed. The chest portion restraining region is configured to be narrow in left-right direction sides in comparison with an upper side region and a lower side region disposed one each on upper and lower sides of the chest portion restraining region.

### CROSS REFERENCE TO RELATED APPLICATIONS

The present application claims priority from Japanese Patent Application No. 2022-130292 of Matsuzaki et al., filed on Aug. 17, 2022, the entire disclosures of which are incorporated herein by reference.

### BACKGROUND

### 1. Technical Field

The present disclosure relates to an occupant protection device for protecting an occupant seated in a seat.

### 2. Description of Related Art

An occupant protection device of a configuration in which a folded airbag is disposed in such a way as to be held in a holding body in front of a hip portion of an occupant seated in a seat, the airbag is caused to protrude from the holding body by an inflating gas being caused to flow into an interior of the airbag, and the airbag is caused to inflate in such a way as to cover the front of the occupant, exists as an occupant protection device, as shown in the specification of US2019/299899. This existing occupant protection device is of a configuration in which, when inflation of the airbag is completed, the occupant is protected by a region on a back face side disposed in an approximately vertical direction in such a way as to cover the front of the occupant from an abdomen portion to a head portion.

This existing occupant protection device is of a configuration in which the back face that restrains the occupant when inflation of the airbag is completed is disposed in an approximately vertical direction. This means that when inflation is completed, a chest portion is immediately received, before the head portion, by the back face when inflation is completed. However, as the airbag in the existing occupant protection device is such that the back face when inflation is completed is of a wide planar form, an unnecessary degree of pressing force is applied to the chest portion, and there is room for improvement in terms of protecting the chest portion gently.

### SUMMARY

An occupant protection device of the present disclosure is for protecting an occupant seated on a seat, and includes the following:
an airbag as a bag form formed of a sheet body having flexibility;
a holding body in which the folded airbag is housed and held, and which is disposed in front of a waist portion of the occupant seated on the seat; and
an inflator that supplies an inflating gas to the airbag, in which
the airbag is configured to protrude from the holding body owing to inflating gas being caused to flow into an interior, and inflating in such a way as to cover a front of the occupant, and includes an occupant side wall portion which can restrain an upper body of the occupant by being disposed on the occupant side when inflation is completed, and
the occupant side wall portion is configured in such a way that a chest portion restraining region that can restrain a chest portion of the occupant by being disposed in an intermediate region in up-down direction sides when inflation is completed is narrow in left-right direction sides in comparison with an upper side region and a lower side region disposed one each on upper and lower sides with the chest portion restraining region as a midpoint.

### BRIEF DESCRIPTION OF DRAWINGS

FIG. 1 is a perspective view of a seat in which an occupant protection device that is one embodiment of the present disclosure is mounted;

FIG. 2 is a side view of the seat of FIG. 1;

FIG. 3 is a front view of the seat of FIG. 1, and shows a state where a seatbelt is worn;

FIG. 4 is a schematic perspective view showing an airbag used in the occupant protection device of the embodiment in a state inflated alone;

FIG. 5 is a schematic back view of the airbag of FIG. 4;

FIG. 6 is a schematic vertical sectional view of the airbag of FIG. 4;

FIG. 7 is a plan view in which base materials configuring the airbag of FIG. 4 are arrayed;

FIG. 8 is a schematic view illustrating a process of forming a tuck portion in the airbag of FIG. 4;

FIG. 9 is a front view of the seat in a state where inflation of the airbag is completed in the occupation protection device of the embodiment;

FIG. 10 is a side view of the seat in a state where inflation of the airbag is completed in the occupation protection device of the embodiment; and

FIG. 11 is a side view of the seat showing a state where an occupant is restrained by the completely inflated airbag in the occupation protection device of the embodiment.

### DETAILED DESCRIPTION

Preferred embodiments of the present invention are described below with reference to the accompanying drawings. However, the invention is not limited to the embodiments disclosed herein. All modifications within the appended claims and equivalents relative thereto are intended to be encompassed in the scope of the claims.

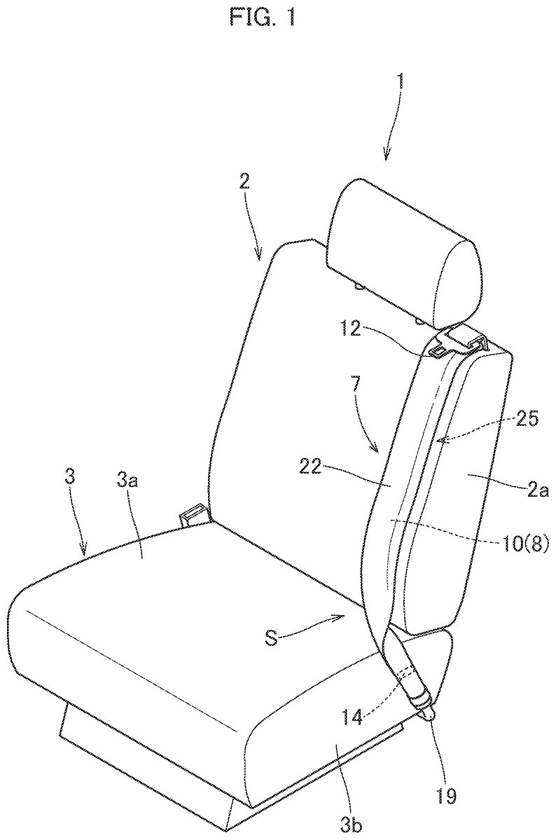

Hereafter, an embodiment of the present disclosure will be described, based on the drawings. As shown in FIGS. 1 to 3, an occupant protection device S of the embodiment is mounted in a seat 1 of a vehicle. The occupant protection device S includes a seatbelt 7 configuring a holding body that holds an airbag 25, the airbag 25, and an inflator 17 that supplies an inflating gas to the airbag 25. The seat 1 includes a backrest portion 2 and a seat portion 3. In the embodiment, front-rear, up-down, and left-right directions coincide with front-rear, up-down, and left-right directions of the seat 1, unless specifically stated otherwise.

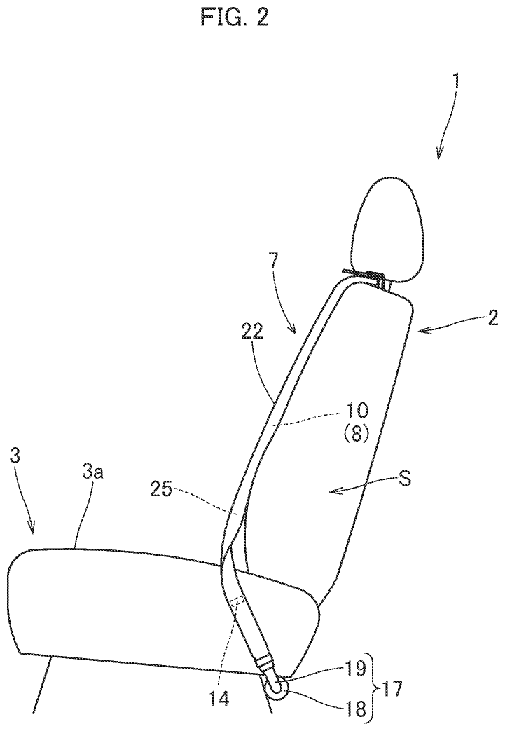

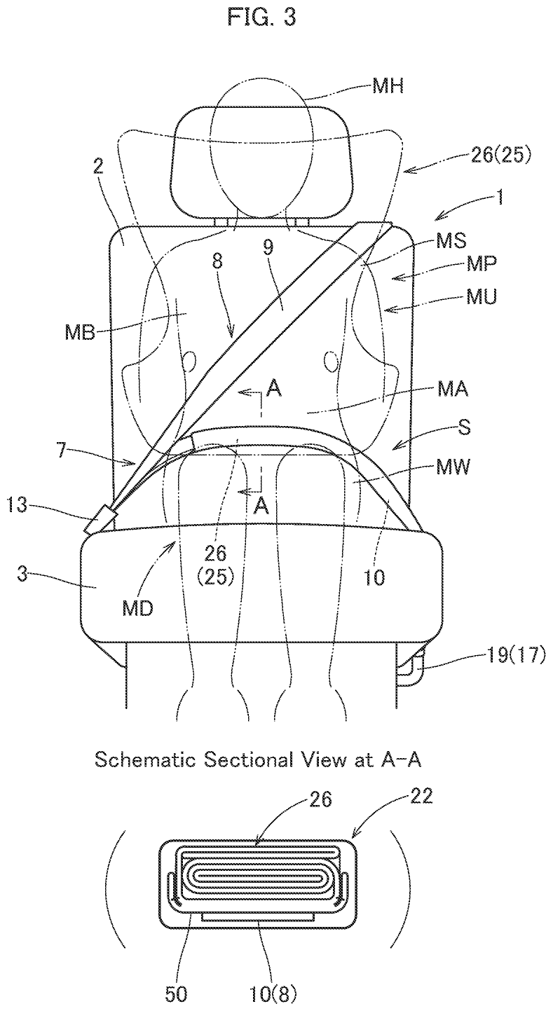

In the case of the embodiment, the seatbelt 7 is mounted in the seat 1, and includes a belt main body 8 for restraining an occupant MP seated on the seat 1, a tongue plate 12 attached to the belt main body 8, and a buckle 13 for causing the tongue plate 12 to be coupled. One end of the belt main body 8 is caused to engage with a take-up shaft of an unshown retractor disposed inside the backrest portion 2. Another end side of the belt main body 8 is engaged to the left of a rear end 3b of the seat portion 3 of the seat 1 (refer to FIGS. 1 and 2) by an anchor member 14. Specifically, the belt main body 8 is disposed in such a way as to be exposed to an exterior from an upper end left edge side of the backrest portion 2. In the case of the embodiment, the belt main body 8 is configured in such a way that, in a state where the occupant MP is not seated, a lap belt 10 acting as a holding body in which the airbag 25 is caused to be held is exposed on a front face of the backrest portion 2, as shown in FIGS. 1 and 2. Specifically, in a state where the occupant MP is not seated, the lap belt 10 is exposed on the front face of the backrest portion 2 in such a way as to approximately follow the up-down direction on a left edge 2a side of the backrest portion 2, as shown in FIG. 1. The belt main body 8 has the lap belt 10, and a shoulder belt 9 housed inside the backrest portion 2. In a state where the tongue plate 12 is coupled to the buckle 13 when the occupant is seated (when worn by the occupant), the lap belt 10 is disposed in such a way as to approximately follow the left-right direction between the anchor member 14 and the buckle 13, thereby restraining a lower body MD (hip portion MW, pelvic region) of the occupant MP. The shoulder belt 9, when worn by the occupant, is disposed obliquely extending from the upper end left edge side of the backrest portion 2 to the buckle 13, thereby restraining an upper body MU (from a shoulder portion MS to a chest portion MB) of the occupant MP (refer to FIG. 3). Further, in the case of the embodiment, the lap belt 10, which is disposed in front of the hip portion MW of the occupant MP seated on the seat 1, and a cover 22 to be described hereafter configure a holding body in which the folded airbag 25 is housed and held. The seatbelt 7 is such that the unshown retractor disposed inside the backrest portion 2 has a pretensioner mechanism.

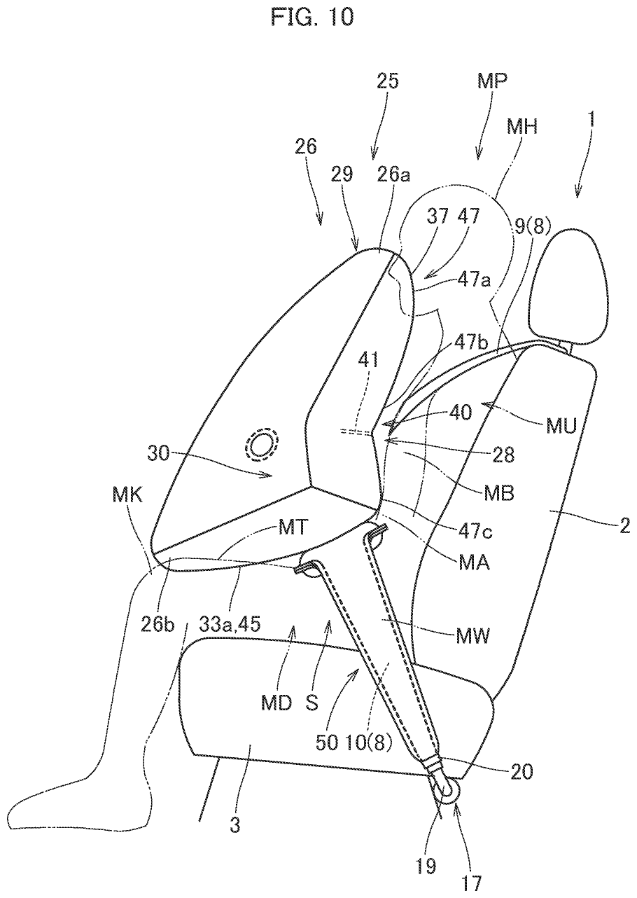

The inflator 17 is mounted in the seat 1. Specifically, in the case of the embodiment, the inflator 17 is disposed in a position below a seat face 3a in the seat 1. As shown in FIG. 2, the inflator 17 includes an inflator main body 18 (a detailed depiction is omitted), whose external form is approximately cylindrical, and a pipe portion 19, which extends from the inflator main body 18 and supplies inflating gas to the airbag 25. The pipe portion 19 extends from the inflator main body 18, and is disposed in such a way that a leading end is positioned in a vicinity of a boundary region between the seat portion 3 and the backrest portion 2 to the left of the seat 1. The leading end of the pipe portion 19 is connected to a conduit portion 50, to be described hereafter, of the airbag 25 by utilizing a clamp 20 (refer to FIG. 10). In the case of the embodiment, the inflator 17 (the inflator main body 18) is set in such a way that an operation start is later than that of the pretensioner mechanism of the seatbelt 7. This is an order to regulate a pulling out of the belt main body 8 of the seatbelt 7 accompanying an inflation of the airbag 25. Specifically, the inflator 17 is set in such a way as to operate 5 ms after an operation of the pretensioner mechanism of the seatbelt 7.

With the lap belt 10 of the seatbelt 7 as a holding body, the airbag 25 is disposed folded into an elongated form, while being held in the lap belt 10, with a periphery covered by the cover 22. Specifically, the airbag 25 is disposed in a region of the lap belt 10, with the periphery covered by the cover 22, in such a way as to be stacked on an upper face side of the lap belt 10 when the seatbelt 7 is worn (refer to FIG. 3). In other words, in the case of the embodiment, the airbag 25 is housed folded in a gap between the lap belt 10 and the cover 22. Also, in the kind of non-worn state shown in FIG. 1, the airbag 25 is disposed on a back face side (the backrest portion 2 side) of the lap belt 10 exposed on the front face of the backrest portion 2. The cover 22 is configured of a sheet body having flexibility, and is configured in such a way that a predetermined place is ruptured when the airbag 25 starts to inflate, enabling a bag main body 26 of the airbag 25 to protrude.

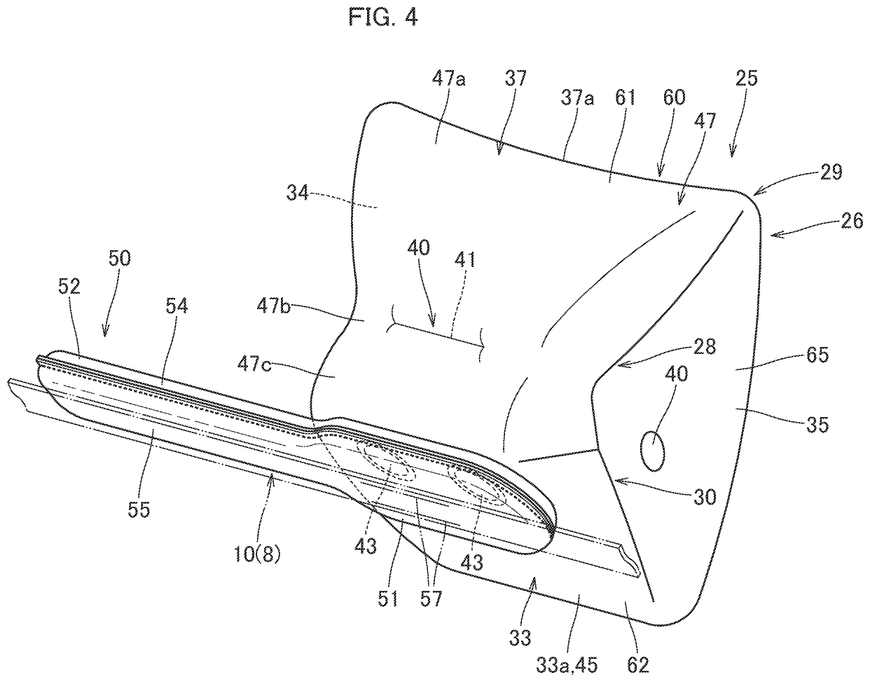

The airbag 25 is formed as a bag formed of a sheet body having flexibility. As shown in FIGS. 4 to 6, the airbag 25 includes the bag main body 26 and the conduit portion 50 which is connected to the inflator 17 and causes inflating gas to flow into the bag main body 26.

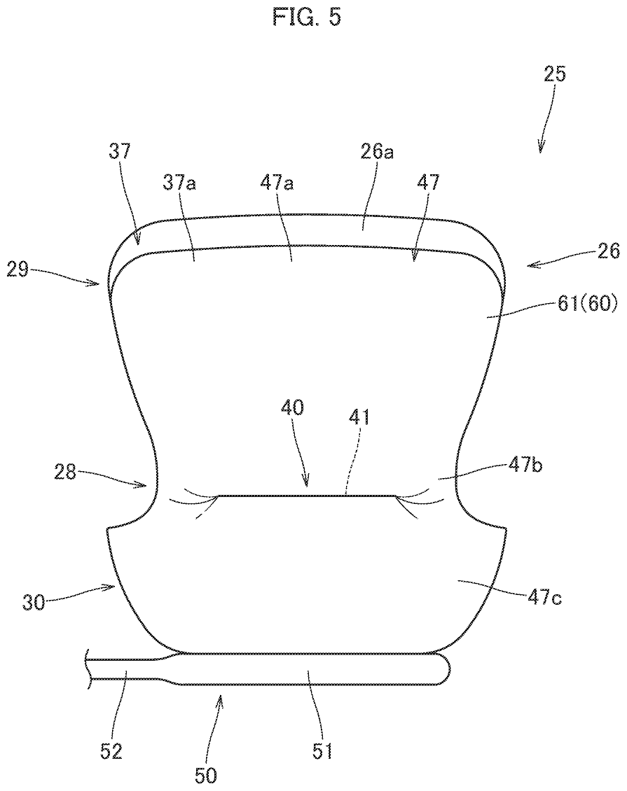

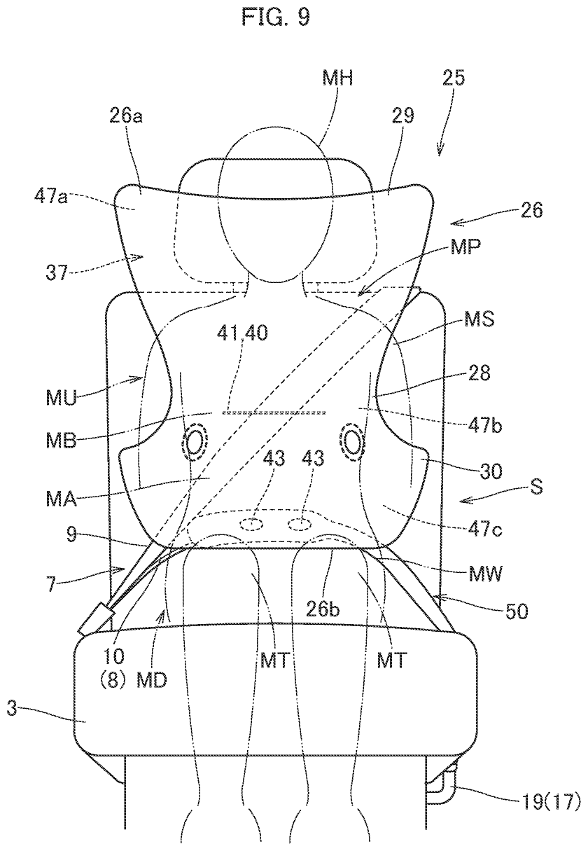

In the case of the embodiment, an external form of the bag main body 26 when inflation is completed is an approximate triangular prism form whose axial direction approximately follows the left-right direction, and which becomes wider front-to-rear toward a lower end side, as shown in FIGS. 4, 6, and 10. Also, in the embodiment, the bag main body 26 is of a form bent in an up-down intermediate region in such a way that a region on an upper end 26a side when inflation is completed is oriented toward the rear, which is the occupant MP side. Furthermore, in the embodiment, a form of the bag main body 26 in a state seen from a front-rear direction side when inflation is completed is such that a region below an up-down center is the widest, a region on an upper side of this lower side wide region (a vicinity slightly below the up-down center) is narrowed in such a way as to be significantly pinched, and a region on an upper end side is wider than the narrowed region, as shown in FIGS. 5 and 9. That is, the bag main body 26 is configured in such a way that, with a narrow portion 28 disposed slightly below the up-down center as a midpoint, an upper side wide portion 29 and a lower side wide portion 30 are disposed one each on upper and lower sides of the narrow portion 28. The narrow portion 28 is disposed in a position corresponding to the chest portion MB of the occupant MP (refer to FIGS. 9 and 10). To describe the external form of the inflated bag main body 26 in detail, the narrow portion 28 neighbors the lower side wide portion 30 on an upper side thereof in a state seen from the front-rear direction side. The lower side wide portion 30 is of a configuration in which a width dimension in the left-right direction gradually decreases toward lower end sides (a front lower end 26b and a rear lower end 26c of the bag main body 26). The upper side wide portion 29 disposed on the upper end 26a side is of a configuration in which a width dimension in the left-right direction gradually increases from the narrow portion 28 (refer to FIGS. 5 and 9).

Specifically, the bag main body 26 has an occupant side wall portion 37 disposed on the occupant MP side (the rear side) when inflation is completed, a front wall portion 32 disposed opposing the occupant side wall portion 37 on a front-rear direction side, a lower wall portion 33 disposed on a lower end side when inflation is completed, and a left wall portion 34 and right wall portion 35 disposed opposing on left-right direction sides when inflation is completed. Also, a bending portion 40 is disposed in an up-down intermediate region of the occupant side wall portion 37, and the occupant side wall portion 37 is configured in such a way as to be caused to bend in the up-down intermediate region when seen from left or right sides in such a way as to cause an upper end 37a side when inflation is completed to protrude to the occupant MP side (rearward). The bending portion 40 is formed in a region of the narrow portion 28 of the bag main body 26, as shown in FIGS. 5 and 9. Also, a venthole 42 through which excess inflating gas that has flowed into an interior can be discharged is formed in the left wall portion 34 and the right wall portion 35. Specifically, each of the ventholes 42 are formed in positions below up-down centers of the left wall portion 34 and the right wall portion 35, on a front edge side.

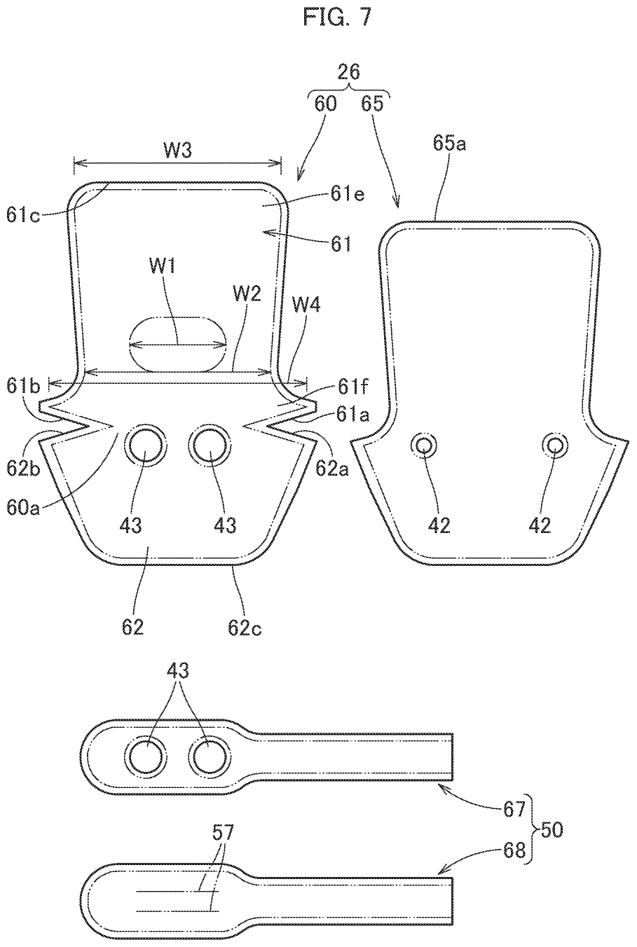

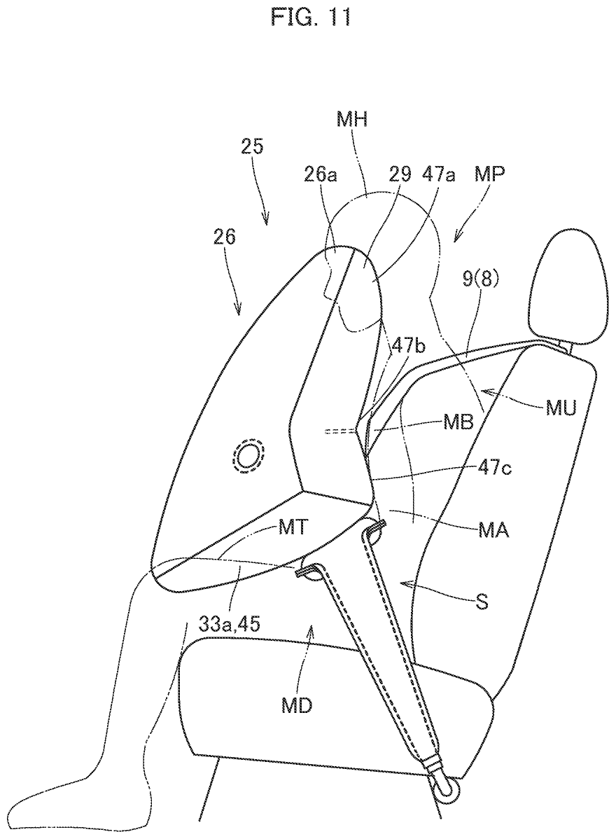

In the bag main body 26 of the embodiment, a lower face 33a of the lower wall portion 33 configures a supported face 45 that comes into contact with a thigh portion MT of the occupant MP, and is supported by the thigh portion MT, when the upper body MU of the occupant MP is received by the bag main body 26 when inflation is completed (refer to FIGS. 10 and 11). The bag main body 26 is in communication with the conduit portion 50 via a communication hole 43 in a region on the rear lower end 26c side (a region on a rear end side of the lower wall portion 33) when inflation is completed. The supported face 45 is configured of a region of the lower wall portion 33 farther to the front side than the conduit portion 50. In a state of the bag main body 26 before receiving the occupant when inflation is completed, the lower wall portion 33 (the supported face 45) is disposed inclined forward and downward (refer to FIG. 10). In the case of the embodiment, the communication hole 43 that causes the conduit portion 50 and the bag main body 26 to communicate opens in a circular form, and two thereof are aligned on left-right direction sides (refer to FIGS. 4 and 7).

Also, in the bag main body 26 of the embodiment, the occupant side wall portion 37, which is disposed on the occupant MP side when inflation is completed, configures an upper body restraining region 47 that can restrain the upper body MU of the occupant MP when inflation is completed (refer to FIG. 10). When inflation of the bag main body 26 is completed, a chest portion restraining region 47b that can restrain the chest portion MB of the occupant MP is disposed in an intermediate region (specifically, in a position below an up-down center) on an up-down direction side of the upper body restraining region 47. A head portion restraining region 47a acting as an upper side region that restrains a head portion MH of the occupant MP is disposed on an upper side of the chest portion restraining region 47b. Also, an abdomen portion restraining region 47c acting as a lower side region that restrains an abdomen portion MA of the occupant MP is disposed on a lower side of the chest portion restraining region 47b (refer to FIG. 5). In the upper body restraining region 47, the chest portion restraining region 47b is configured of a region corresponding to the narrow portion 28 of the bag main body 26. The head portion restraining region 47a and the abdomen portion restraining region 47c are configured of regions corresponding respectively to the upper side wide portion 29 and the lower side wide portion30 of the bag main body 26 (refer to FIGS. 5 and 10). That is, the upper body restraining region 47 is configured in such a way that, with the chest portion restraining region 47b as a midpoint, the head portion restraining region 47a (the upper side region) and the abdomen portion restraining region 47c (the lower side region) are disposed one each on upper and lower sides of the chest portion restraining region 47b. Compared with the head portion restraining region 47a (the upper side region) and the abdomen portion restraining region 47c (the lower side region) disposed one each on upper and lower sides with the chest portion restraining region 47b as a midpoint, the chest portion restraining region 47b is configured in such a way as to be narrow in left-right direction sides. Also, an external form of the upper body restraining region 47 (the occupant side wall portion 37) in a state seen from a front-rear direction side is configured to approximately coincide with the external form of the bag main body 26 in a state seen from a front-rear direction side when inflation is completed. That is, the narrow chest portion restraining region 47b neighbors the wide abdomen portion restraining region 47c (the lower side region) on the upper side thereof, and the abdomen portion restraining region 47c (the lower side region) is configured in such a way that a width dimension in the left-right direction gradually decreases toward a lower end side. A configuration is such that a width dimension in the left-right direction gradually increases from the chest portion restraining region 47b toward the wide head portion restraining region 47a (the upper side region) disposed on an upper end side (refer to FIG. 5).

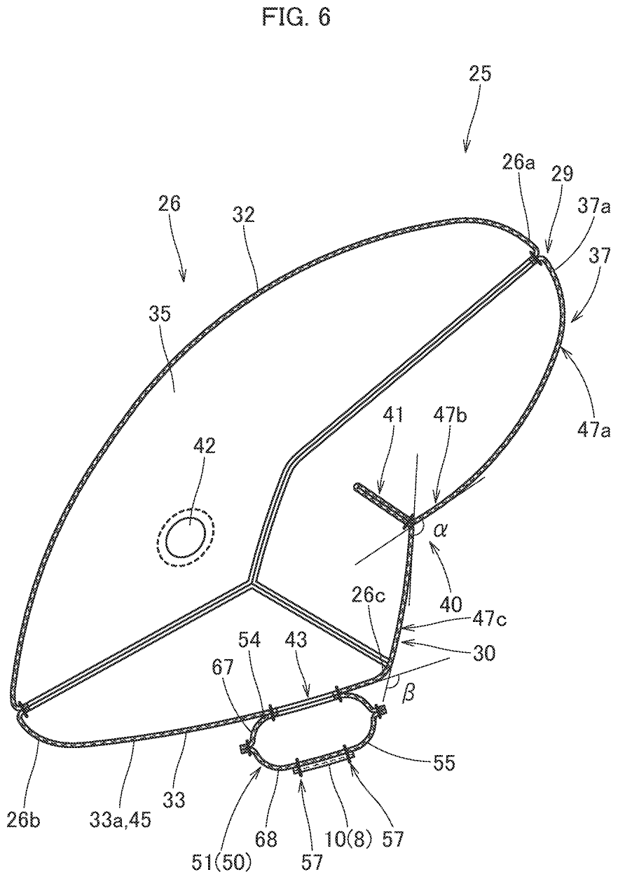

Also, as heretofore described, the bag main body 26 of the embodiment is such that the bending portion 40 is disposed in a region of the narrow portion 28, that is, in the chest portion restraining region 47b of the upper body restraining region 47, and is disposed in such a way that when inflation of the bag main body 26 is completed, the head portion restraining region 47a (the upper side region, the upper side wide portion 29) of the upper body restraining region 47 is caused to protrude to the occupant MP side (the rear side) with respect to the abdomen portion restraining region 47c (the lower side region, the lower side wide portion 30) by the bending portion 40 (refer to FIG. 6). In the case of the embodiment, the bending portion 40 is configured of a region of a tuck portion 41 formed by pinching regions of the occupant side wall portion 37 separated on up-down direction sides, and causing the regions to join each other.

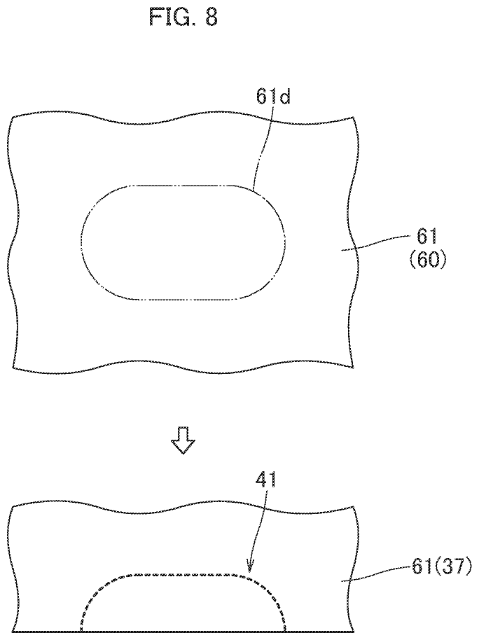

Specifically, in a state where an upper side region 61 of an occupant side panel 60, to be described hereafter, configuring the occupant side wall portion 37 is flattened, the tuck portion 41 is formed in a region of a future tuck formation portion 61d of an approximately oval form that approximately follows the left-right direction (refer to FIG. 7). As shown in FIG. 8, the tuck portion 41 can be formed by partially pinching the upper side region 61, folding the upper side region 61 into two portions, and joining the portions of the upper side region 61 (the occupant side wall portion 37) to each other by sewing (joining) the future tuck formation portion 61d. The future tuck formation portion 61d is disposed in a region of the upper side region 61 that configures a narrow portion 28. In the case of the embodiment, the tuck portion 41 is formed in such a way as to protrude to the front of the occupant side wall portion 37 (to an inner side of the bag main body 26) (refer to FIG. 6). As heretofore described, the tuck portion 41 is disposed in a region of the narrow portion 28 of the bag main body 26 when inflation is completed, in other words, disposed in the chest portion restraining region 47b of the upper body restraining region 47 (a position in front of the chest portion MB of the occupant MP) (refer to FIGS. 9 and 10). Also, in the case of the embodiment, a width dimension W1 in left-right direction of the tuck portion 41 (the future tuck formation portion 61d) is set to be in the region of one-half of a width dimension W2 in left-right direction of a region configuring the narrow portion 28 (the chest portion restraining region 47b) in a state where the occupant side wall portion 37 (the upper side region 61 of the occupant side panel 60) is flattened (refer to FIG. 7).

The bag main body 26 of the embodiment is such that in a vertical cross-section approximately following the front-rear direction in a state where the bag main body 26 is inflated alone, an angle of intersection α between tangents of the head portion restraining region 47a and the abdomen portion restraining region 47c is set to be in the region of 130° (refer to FIG. 6). Also, an angle of intersection β between tangents of the lower wall portion 33 (the supported face 45) and the abdomen portion restraining region 47c in a state where the bag main body 26 is inflated alone is set to be in the region of 130° (refer to FIG. 6). Also, in the embodiment, a width dimension in front-rear direction on the lower end side of the bag main body 26 when inflation is completed is set to be a dimension such that a front end of the lower wall portion 33 (the front lower end 26b of the bag main body 26) is positioned slightly behind a knee MK of the occupant MP. A width dimension in up-down direction on a rear end side of the bag main body 26 when inflation is completed is set to be a dimension such that the upper end 26a (the upper end 37a of the occupant side wall portion 37, and the head portion restraining region 47a) is positioned in front of the head portion MH of the occupant MP (refer to FIG. 10). Also, a width dimension in left-right direction of the bag main body 26 when inflation is completed is smaller than the backrest portion 2 of the seat 1, and configured in such a way that wide regions (the upper side wide portion 29 and the lower side wide portion 30) are approximately equivalent to the upper body MU (refer to FIG. 9). According to this kind of bag main body 26, the upper body MU of the occupant MP can be protected stably. In the case of the embodiment, the bag main body 26 when inflation is completed is such that the upper side wide portion 29 (the head portion restraining region 47a) and the lower side wide portion 30 (the abdomen portion restraining region 47c) are configured in such a way that width dimensions in left-right direction are approximately equal. Also, a width dimension in left-right direction of the narrow portion 28 (the chest portion restraining region 47b) is set to be in the region of three-fifths of that of the upper side wide portion 29 (the head portion restraining region 47a) or the lower side wide portion 30 (the abdomen portion restraining region 47c) (refer to FIGS. 5 and 9).

The conduit portion 50 is configured in such a way as to extend leftward from the bag main body 26. The conduit portion 50 is of an approximately tubular form in which a leading end side is opened, and is connected to the pipe portion 19 of the inflator 17. The conduit portion 50 is disposed approximately following the left-right direction in such a way as to approximately follow the lap belt 10 when inflation of the airbag 25 is completed. The conduit portion 50 includes a base portion side region 51 disposed on a lower face side of the bag main body 26 and a leading end side region which is disposed on the left of the bag main body 26. The leading end side region 52 is connected to the inflator 17. The base portion side region 51 is set wider than the leading end side region 52. Two communication holes 43 communicating with the bag main body 26 are formed in the base portion side region 51 of the conduit portion 50. The airbag 25 of the embodiment is attached to the lap belt 10 by the base portion side region 51 of the conduit portion 50 being sewn directly to the lap belt 10 (refer to FIG. 6). Also, the conduit portion 50 is of a configuration that includes an upper wall portion 54 and a lower wall portion 55 disposed opposing on up-down direction sides, or more specifically, a region on the base portion side of the lower wall portion 55 (a region configuring the base portion side region 51) is sewn to the lap belt 10 using sewing thread. In the case of the embodiment, a stitching region 57 in which the lap belt 10 and the conduit portion 50 are sewn together is formed in a double line form approximately along a length direction of the lap belt 10 (refer to FIGS. 4 and 7).

The airbag 25 of the embodiment is configured by peripheral edges of a base fabric of a predetermined form being joined together. In the case of the embodiment, the airbag 25 is configured of the occupant side panel 60 and a front side panel 65, which configure the bag main body 26, and two conduit portion panels 67 and 68 that configure the conduit portion 50, as shown in FIG. 7. Each of the occupant side panel 60, the front side panel 65, and the conduit portion panels 67 and 68 is formed of a woven fabric having flexibility formed of a polyester thread, a polyamide thread, or the like.

The occupant side panel 60 is disposed on the occupant MP side when inflation is completed, and mainly configures a region from the occupant side wall portion 37 to the lower wall portion 33. Specifically, the occupant side panel 60 includes the upper side region 61 which mainly configures the occupant side wall portion 37, and a lower side region 62 that mainly configures the lower wall portion 33. Further, the occupant side panel 60 is of an external form such that the upper side region 61 and the lower side region 62 are linked in a region configuring the rear lower end 26c side of the bag main body 26. The upper side region 61 configures the occupant side wall portion 37 and a rear side regions of the left wall portion 34 and the right wall portion 35. The upper side region 61 is configured in such a way that, in a flattened state, a vicinity of a lower end 61f is widest, a region immediately above this wide region is narrow, and a width dimension increases slightly toward an upper end 61e side. Specifically, a width dimension W3 in left-right direction of a region on the upper end 61e side of the upper side region 61 in a flattened state (a region configuring the upper side wide portion 29 (the head portion restraining region 47a) of the bag main body 26 when inflation is completed) is set to be in the region of nine-eighth of the width dimension W2 in the left-right direction of the region configuring the narrow portion 28 (the chest portion restraining region 47b), which is the narrowest portion. Also, the width dimension W3 is set to be smaller than a width dimension W4 in the left-right direction of a region on the lower end 61f side (a region configuring the lower side wide portion 30 (the abdomen portion restraining region 47c) of the bag main body 26 when inflation is completed). The width dimension W4 in left-right direction of the region on the lower end 61f side of the upper side region 61 is set to be in the region of three-second of the width dimension W2 in the left-right direction of the region configuring the narrow portion 28 (the chest portion restraining region 47b). The lower side region 62 configures the lower wall portion 33 and regions on a lower side of the left wall portion 34 and the right wall portion 35. An external form of the lower side region 62 in a flattened state is an approximately trapezoidal form such that the upper side region 61 side is widest, and a width dimension gradually decreases toward a front edge 62c. A width dimension in left-right direction on the upper side region 61 side of the lower side region 62 approximately coincides with a width dimension in left-right direction on the lower end 61f side of the upper side region 61.

The front side panel 65 mainly configures a region of the front wall portion 32 (specifically, the front wall portion 32 and regions on a front side of the left wall portion 34 and the right wall portion 35) of the bag main body 26 when inflation is completed. An external form of the front side panel 65 in a flattened state is configured in such a way as to approximately coincide with the lower side region 62 and the upper side region 61 in a state opened in such a way that edge portions (an upper edge 61c and the front edge 62c), remaining after a lower left edge 61a and a rear left edge 62a, and a lower right edge 61b and a rear right edge 62b, disposed on a left and right of a linking region 60a in which the upper side region 61 and the lower side region 62 are caused to link in the occupant side panel 60 are joined, are separated from each other.

The front side panel 65 and the occupant side panel 60 each have bilaterally symmetrical forms. Further, as heretofore described, the bag main body 26 of the embodiment is formed as a bag by the upper edge 61c and the front edge 62c of the occupant side panel 60 and an outer peripheral edge 65a of the front side panel 65 being caused to join, in a state where the lower left edge 61a and the back left edge 62a, and the lower right edge 61b and the back right edge 62b, are joined to each other.

The two conduit portion panels 67 and 68 are of the same external form, and configure the upper wall portion 54 and the lower wall portion 55 respectively of the conduit portion 50.

The occupant protection device S of the embodiment is such that when the inflator 17 operates in a state where the occupant MP is seated while wearing the seatbelt 7 in the seat 1 mounted in a vehicle, inflating gas discharged from the inflator 17 flows into the bag main body 26 via the conduit portion 50. Further, the bag main body 26 of the airbag 25 completes inflation while protruding forward and upward from the lap belt 10 in such a way as to cause the cover 22 to rupture, as shown by a two-dotted chain line in FIG. 3 and in FIGS. 9 and 10.

Further, the occupant protection device S of the embodiment is such that in the occupant side wall portion 37 that restrains the upper body MU of the occupant MP when inflation of the airbag 25 is completed, the chest portion restraining region 47b that can restrain the chest portion MB of the occupant MP is configured to be narrow in left-right direction in comparison with the head portion restraining region 47a acting as the upper side region and the abdomen portionrestraining region 47c acting as the lower side region, which are disposed one each on the upper and lower sides (refer to FIG. 9). In other words, the occupant protection device S of the embodiment is such that in a state where inflation of the airbag 25 (the bag main body 26) is completed, a film length in a cross-section following the left-right direction of the chest portion restraining region 47b is set to be shorter than a film length in a cross-section following the left-right direction of each of the head portion restraining region 47a and the abdomen portion restraining region 47c. This means that when inflation of the airbag 25 is completed, an aspect is such that the chest portion restraining region 47b is disposed in such a way as to be partially recessed with respect to the head portion restraining region 47a and the abdomen portion restraining region 47c. As a result of this, an area of contact with the chest portion MB of the airbag 25 when inflation is completed can be reduced in comparison with an airbag that inflates in such a way as to be of approximately the same diameter over an approximate whole up-down region. Further, an unnecessary degree of pressing force being applied to the chest portion MB by the inflated airbag 25 can be restricted.

Consequently, the occupant protection device S of the embodiment is such that the chest portion MB of the occupant MP can be received gently.

In particular, the occupant protection device S of the embodiment is such that when inflation of the bag main body 26 is completed, a region corresponding to the chest portion restraining region 47b is configured, as the narrow portion 28, to be narrower than the upper side wide portion 29 which is a region corresponding to the head portion restraining region 47a (the upper side region), and the lower side wide portion 30 which is a region corresponding to the abdomen portion restraining region 47c (the lower side region). That is, the occupant protection device S of the embodiment is such that the bag main body 26 itself when inflation is completed is configured in such a way that width dimensions partially differ in up-down direction. Furthermore, the occupant protection device S of the embodiment is such that this kind of irregular form of the bag main body 26 itself when inflation is completed is configured by providing corresponding edge portions (the upper edge 61c and the outer peripheral edge 65a) of the upper side region 61 configuring the occupant side panel 60 and the front side panel 65 with irregularity, and causing corresponding edge portions (the upper edge 61c, the front edge 62c, and the outer peripheral edge 65a) of the occupant side panel 60 and the front side panel 65 to join in a plane. Because of this, a state of narrowness of the chest portion restraining region 47b with respect to the head portion restraining region 47a and the abdomen portion restraining region 47c (a recessed state on the left-right direction sides of the narrow portion 28 with respect to the upper side wide portion 29 and the lower side wide portion 30) in the bag main body 26 when inflation is completed can be secured stably.

Also, the occupant protection device S of the embodiment is such that the occupant side wall portion 37 is configured in such a way that the bending portion 40 is disposed in the chest portion restraining region 47b, and the head portion restraining region 47a acting as the upper side region is caused to protrude to the occupant MP side with respect to the abdomen portion restraining region 47c acting as the lower side region when inflation is completed (refer to FIG. 10). This means that when inflation of the airbag 25 is completed, the head portion restraining region 47a (the upper side region) of the inflated bag main body 26, firstly, comes into contact with the head portion MH or the shoulder portion MS (the head portion MH in the case of the embodiment), as shown in FIG. 11, and a pressing force being applied to the chest portion MB by the inflated airbag 25 can be further restricted. Specifically, a configuration of the occupant protection device S of the embodiment is such that by the tuck portion 41 being provided in the chest portion restraining region 47b, the occupant side wall portion 37 is caused to bend, and the head portion restraining region 47a is caused to protrude to the occupant MP side with respect to the abdomen portion restraining region 47c. When this kind of point is not taken into consideration, a configuration in which an occupant side wall portion is not caused to bend, and an upper side region (a head portion restraining region) is not caused to protrude with respect to a lower side region (an abdomen portion restraining region) may be adopted.

The occupant protection device S of the embodiment is such that the lap belt 10 of the seatbelt 7 is utilized as a holding body in which the airbag 25 is caused to be held. However, a holding body in which an airbag is caused to be held is not limited to a lap belt. For example, a configuration in which a holding body separate from a seatbelt is provided, and an airbag is caused to be held in the holding body, may be adopted. In the occupant protection device S of the embodiment, while a configuration is such that the airbag 25 is caused to be held in the lap belt 10 of the seatbelt 7, the inflator 17 operates later (in the region of 5 ms) than an operation of the pretensioner mechanism of the seatbelt 7. Because of this, the airbag 25 can be caused to inflate in a state where a seated state of the occupant MP with respect to the seat 1 is stably maintained by the seatbelt 7, and the occupant MP can be stably protected by the airbag 25 and the seatbelt 7.

Also, the occupant protection device S of the embodiment is such that the seatbelt 7 and the inflator 17 are of a configuration mounted in the seat 1. This means that even when used in a state where the seat 1 is moved with respect to the vehicle by being significantly slid to the front or rear or rotated, the occupant MP seated in the seat 1 can be appropriately protected by the airbag 25. Of course, an occupant protection device of the invention not being limited to the seat 1 of this kind of configuration, the occupant protection device can also be mounted in a type of seat in which an occupant is restrained by a seatbelt such that a retractor is provided on a vehicle body side. Also, a configuration in which an inflator is also attached on the vehicle body side may be adopted.

The invention relates to an occupant protection device of the following configuration.

An occupant protection device for protecting an occupant seated on a seat includes the following:
an airbag as a bag form formed of a sheet body having flexibility;
a holding body in which the folded airbag is housed and held, and which is disposed in front of a waist portion of the occupant seated on the seat; and
an inflator that supplies an inflating gas to the airbag, in which
the airbag is configured to protrude from the holding body owing to inflating gas being caused to flow into an interior, and inflating in such a way as to cover a front of the occupant, and includes an occupant side wall portion which can restrain an upper body of the occupant by being disposed on the occupant side when inflation is completed, and
the occupant side wall portion is configured in such a way that a chest portion restraining region that can restrain a chest portion of the occupant by being disposed in an intermediate region in up-down direction sides when inflation is completed is narrow in left-right direction sides in comparison with an upper side region and a lower side region disposed one each on upper and lower sides with the chest portion restraining region as a midpoint.

The occupant protection device of the invention is such that in an occupant side wall portion that restrains an upper body of an occupant when inflation of an airbag is completed, a chest portion restraining region that can restrain a chest portion of the occupant is configured to be narrow in left-right direction in comparison with an upper side region and a lower side region disposed one each on upper and lower sides. In other words, the occupant protection device of the invention is such that in a state where inflation of the airbag is completed, a film length in a cross-section following the left-right direction of the chest portion restraining region is set to be shorter than a film length in a cross-section following the left-right direction of each of the upper side region and the lower side region. This means that when inflation of the airbag is completed, an aspect is such that the chest portion restraining region is disposed in such a way as to be partially recessed with respect to the upper side region and the lower side region. As a result of this, an area of contact with the chest portion of the airbag when inflation is completed can be reduced in comparison with an airbag that inflates in such a way as to be of approximately the same diameter over an approximate whole up-down region. Further, an unnecessary degree of pressing force being applied to the chest portion by the inflated airbag can be restricted.

Consequently, the occupant protection device of the invention is such that a chest portion of an occupant can be received gently.

Also, the occupant protection device of the invention is such that the occupant side wall portion is preferably configured in such a way that a bending portion is disposed in the chest portion restraining region, and the upper side region is caused to protrude to the occupant side with respect to the lower side region when inflation is completed. By adopting this kind of configuration for the occupant protection device, the upper side region of the inflated airbag firstly comes into contact with a head portion or a shoulder portion, and a pressing force being applied to the chest portion by the inflated airbag can be further restricted.

What is claimed is:

1. An occupant protection device for protecting an occupant seated on a seat, comprising:
an airbag as a bag form formed of a sheet body having flexibility;
a holding body in which the folded airbag is housed and held, and which is disposed in front of a waist portion of the occupant seated on the seat; and
an inflator that supplies an inflating gas to the airbag, wherein
the airbag is configured to protrude from the holding body owing to inflating gas being caused to flow into an interior, and inflating in such a way as to cover a front of the occupant, and includes an occupant side wall portion which can restrain an upper body of the occupant by being disposed on the occupant side when inflation is completed, and
the occupant side wall portion is configured in such a way that a chest portion restraining region that can restrain a chest portion of the occupant by being disposed in an intermediate region in up-down direction sides when inflation is completed is narrow in left-right direction sides in comparison with an upper side region and a lower side region disposed one each on upper and lower sides with the chest portion restraining region as a midpoint.

2. The occupant protection device according to claim 1, wherein
the occupant side wall portion is configured in such a way that a bending portion is disposed in the chest portion restraining region, and the upper side region is caused to protrude to an occupant side with respect to the lower side region when inflation is completed.

3. The occupant protection device according to claim 1, wherein
the airbag includes a bag main body, and a conduit portion that is connected to the inflator and causes an inflating gas to flow into the bag main body, wherein
the bag main body includes a narrow portion, which is disposed in an up-down intermediate region when inflation is completed, and an upper side wide portion and a lower side wide portion disposed one each on upper and lower sides of the narrow portion, and
the narrow portion corresponds to the chest portion restraining region.

4. The occupant protection device according to claim 1, wherein
the holding body is configured of a lap belt that restrains the hip portion of the occupant when a seat belt is worn.

5. The occupant protection device according to claim 4, wherein
the seatbelt and the inflator are of a configuration mounted in the seat.
